(19) United States
(12) Patent Application Publication
(10) Pub. No.: US 2015/0081344 A1
(43) Pub. Date: Mar. 19, 2015

(54) INSURANCE PRODUCTS FOR A CAMERA DEVICE COUPLED TO A VEHICLE

(71) Applicant: Esurance Insurance Services, Inc., San Francisco, CA (US)

(72) Inventor: Charles Sung LEE, Piedmont, CA (US)

(21) Appl. No.: 14/488,081

(22) Filed: Sep. 16, 2014

Related U.S. Application Data
(60) Provisional application No. 61/879,538, filed on Sep. 18, 2013.

(51) Int. Cl. G06Q 40/08; B60R 1/00; B60R 11/04

(52) U.S. Cl. CPC G06Q 40/08; B60R 1/00; B60R 11/04; B60R 2300/80; B60R 2011/0005
USPC 705/4

(57) ABSTRACT

Various aspects of the subject technology relate to systems, methods, and machine-readable media for providing an insurance product to a user with a camera device coupled to a vehicle. A system is configured to receive user data from at least one camera device coupled to a vehicle, wherein the user data comprises video data, determine whether a set of criteria is met based on the user data, and providing an insurance product to a user associated with the camera device when the set of criteria is met.

### CROSS-REFERENCE TO RELATED APPLICATIONS

The present disclosure is related and claims priority to U.S. Provisional Patent Application No. 61/879,538, entitled DASHBOARD CAMERA INSURANCE PRODUCTS, filed on Sep. 18, 2013, by Charles Sung Lee, the contents of which are hereby incorporated by reference in their entirety, for all purposes.

### BACKGROUND

The present disclosure generally relates to insuring vehicles and, in particular, to providing customers with insurance products.

Some automobile drivers have installed video cameras (e.g., “dash cams”) in their vehicles to record out of the front windows of the vehicles. These dash cams may be used to record traffic incidents. The videos recorded by the dash cams may be used as a reliable source of information when reconstructing the causes of a traffic incident. The videos may be used in addition to or instead of eye witness testimony.

### SUMMARY

Various aspects of the subject technology relate to system for offering one or more insurance products to a customer with a camera device coupled to a vehicle. The system includes one or more processors and a machine-readable medium comprising instructions stored therein, which when executed by the one or more processors, cause the one or more processors to perform operations. The operations include receiving user data from at least one camera device coupled to a vehicle, wherein the user data comprises video data, storing the video data on a memory, determining whether a set of criteria is met based on the user data, and providing an insurance product to a user associated with camera device when the set of criteria is met.

Some aspects of the subject technology relate to a method for offering an insurance product to a user associated with a camera device coupled to a vehicle. The method includes receiving user data from at least one camera device coupled to a vehicle, wherein the user data comprises video data, determining whether a set of criteria is met based on the user data, and providing, using a processor, an insurance product to a user associated with the camera device when the set of criteria is met.

Some aspects of the subject technology relate to a non-transitory machine-readable medium comprising instructions stored therein, which when executed by a machine, cause the machine to perform operations. The operations include receiving a video feed from at least one camera device associated with a user of an insurance platform, storing the video feed for a period of time on a memory, and providing a discount to the user based on the storing of the video feed.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a block diagram illustrating an example environment in which a system for providing an insurance product to users associated with a camera device coupled to a vehicle may exist, in accordance with various aspects of the subject technology.

FIG. 2 is a block diagram illustrating an example camera device that may be coupled to a vehicle, in accordance with various aspects of the subject technology.

FIG. 3 is a flow chart illustrating an example process for providing an insurance product to a user, in accordance with various aspects of the subject technology.

FIG. 4 is a flow chart illustrating an example process for using the stored user data, in accordance with various aspects of the subject technology.

FIG. 5 is a flow chart illustrating another example process for using the stored user data, in accordance with various aspects of the subject technology.

FIG. 6 is a flow chart illustrating another example process for using the stored user data, in accordance with various aspects of the subject technology.

FIG. 7 is a block diagram illustrating an example computer system with which any of the computing machines, devices, or systems discussed herein may be implemented, in accordance with some aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Insurance fraud is a highly problematic issue for the insurance industry. While the extent to which it is prevalent in some geographic regions (e.g., United States) may pale in comparison to other places, it is still prevalent. Most fraud detection and investigation happens after an accident with little real time input from any source. Some insurance companies spend significant amounts of money on special investigation units (insurance) who try to decipher any fraud.

According to various aspects of the subject technology, a system may be configured to provide an insurance product to a user (e.g., a customer) with one or more camera devices installed in the user's vehicle. The insurance products may include, for example, a discount (e.g., an automobile insurance discounted rate) for users with an installed camera device.

The system may be configured to automatically provide an insurance product to a user once the system verifies that a camera device is installed on the user's vehicle and configured to automatically record video and transmit recorded video data to the system. The recorded video data may provide the system with an accurate depiction events or conditions in the case that a traffic incident occurs. The video data may be used to, for example, determine the cause of a traffic incident and prevent insurance fraud. The user, on the other hand, may receive one or more insurance products or offers for insurance products with lower fees that may reduce what the user pays, thereby making the relationship between the system and the user more symbiotic and beneficial.

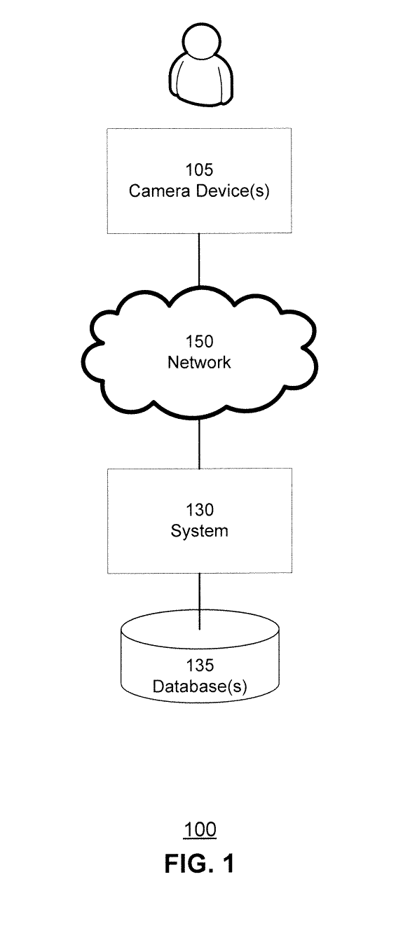

FIG. 1 is a block diagram illustrating an example environment 100 in which a system for providing an insurance product to users associated with a camera device coupled to a vehicle may exist, in accordance with various aspects of the subject technology. The network environment includes one or more camera devices 105 on a user's vehicle. The one or more camera devices 105 are configured to record video data and transmit the video data to a system 130 over a network 150, such as the internet.

The network 150 may include, for example, any one or more of a cellular network, a satellite network, a personal area network (PAN), a local area network (LAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The system 130 may be implemented on one or more computing machines in communication with the network 150. The system 130 may be associated with an insurance platform provided by an insurance company and include one or more server machines affiliated with the insurance company. For example, the system 130 may belong to an insurance company or another party associated with an insurer.

The system 130 is configured to register the one or more camera devices 105 for a user, determine whether criteria for providing an insurance product are met, and provide the insurance product to the user if the criteria are met. The system 130 may further be configured to receive the video data from the camera devices 105 and store the video data in a memory such as in one or more databases 135 shown in FIG. 1. According to some aspects of the subject technology, the video data may only be stored temporarily for a period of time (e.g., 2 weeks), for example, greater than a time period in which a user is required to submit an insurance claim. After the period of time expires, the video data may be deleted to free up storage space for new video data and/or to address long term privacy concerns users may have.

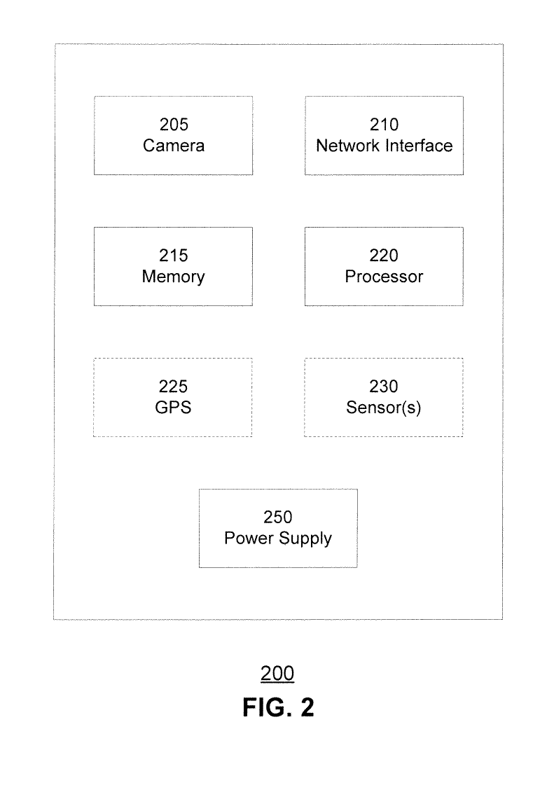

FIG. 2 is a block diagram illustrating an example camera device 200 that may be coupled to a vehicle, in accordance with various aspects of the subject technology. Examples of a camera device 200 may include a dashboard camera (e.g., a dashcam) that a user may have mounted on the dashboard or elsewhere in the cabin of the user's vehicle. For example, the camera device 200 may be installed on the vehicle's front windshield, on the ceiling or roof of the vehicle, or on another console. The camera device 200 may be installed on or in the vehicle itself. For example, the camera device 200 may be installed into a front or rear bumper, a rear or side mirror, or on any other part of a vehicle.

The camera device 200 may be configured to record and/or transmit recorded data (e.g., video data) to a server. The camera device 200 may be front-facing and record data received from the front of the vehicle, rear-facing and record data received from the rear of the vehicle, or directed in another direction (e.g., directed toward the interior of the cabin and record data from the inside of the car). In some cases the camera device 200 may optionally record and/or transmit audio data or other drive time data (e.g., location, speed, etc.).

The camera device 200 may include, for example, a camera 205, a network interface 210, a memory 215, and a processor 220. In other aspects, however, the camera device 200 may include additional components, fewer components, or different components. Furthermore, some components shown in FIG. 2 as being a part of the camera device 200 may be separate devices in communication with the camera device according to other aspects. The camera 205 is configured to capture recorded data. The recorded data may include, for example, video data (e.g., a video feed) and/or image data (e.g., still images).

The network interface 210 is configured to transmit user data generated by the camera device 200 to the system 130 in FIG. 1 and/or receive data (e.g., instructions) from the system 130. The user data may include any recorded data from the camera 205 or any other component of the camera device 200. The network interface 210 may be configured to communicate with the system 130 via a network 150 such as a third generation (3G) cellular telecommunications network, a fourth generation (4G) cellular telecommunications network, other telecommunications networks, or a combination of different networks.

According to some aspects, the camera device 200 may also include one or more memories 215 configured to buffer the recorded video until it can be transmitted to the system 130. The memory 215 may be large enough to hold the video recording for a particular period of time (e.g., a week). Accordingly, if the camera device 200 is not able to transmit the video content to the server via the network interface 210 for some reason (e.g., if the network 150 is experiencing low bandwidth, out of service, or out of range), the video content may be stored in the memory 215 until it has a chance to be transmitted to the system 130.

The one or more memories 215 may also include a machine-readable medium (also referred to as a computer-readable medium) storing one or more sets of instructions. Some instructions stored on the one or more memories 215 may further be transmitted or received over a network 150 via the network interface 210 from the system 130 or from another party. The instructions may be executed by the processor 220 to perform one or more functions.

For example, according to some aspects of the subject technology, the network interface 210 the system may receive instructions from the system 130 to control various components of the camera device 200. The instructions, for example, may be configured to change a zoom level, a focus setting, or an angle of view for the camera 205. Similarly, the instructions may change various other settings on the camera device 200 or instruct the camera device 200 to execute various operations.

The camera device 200 may also include a power supply 250 configured to provide the camera device 200 with power. The power supply 250 may be configured to interface with an external power source such as a vehicle power outlet or an external battery. The power supply 250 may also include an internal battery that may enable the camera device 200 to continue to function even if power from the vehicle is lost. The internal battery may then be recharged when power from the vehicle is restored.

According to other aspects of the subject technology, the camera device 200 may optionally include additional components such as a global positioning system (GPS) component 225 and one or more additional sensors 230. The additional sensors 230 may include, for example, proximity sensors. The data (geographical location coordinates or proximity data) generated by the GPS component and the additional sensors 230 may also be transmitted to the system 130 and stored.

According to some aspects of the subject technology, in order to provide the user with insurance products such as a discount on an auto insurance policy, the system 130 may require that certain criteria be met. The criteria may include, for example, a requirement that the camera device 105 be properly installed, that the camera device 105 begin transmitting a video feed to the system, and/or that the user be properly registered and eligible to receive the insurance product.

Other criteria may include that the camera device 105 have transmitted a certain amount of video data to the system 130 or that the quality of the video data have certain characteristics. For example, the system 130 may require that the camera device 105 be installed in a vehicle such that the recorded video has a viewing radius equal to or more than a threshold viewing radius (e.g., a minimum viewing radius). The system 130 may also require that the camera device 105 be pointed at a particular angle or range of angles.

An application may be installed on a user's computing machine (e.g., a laptop, a mobile phone, a tablet, the camera device 105, or other computing device) that includes instructions to guide the user to properly install and set up the camera device 105 and register the camera device 105 with the system 130. The application may also communicate with one or more of the servers associated with the system 130 in order to register the camera device 105 with the system 130 and link a user's insurance account (or other account) with the camera device 105. The application may also display the user's insurance information and indicate whether or not the customer has received a discount for having the camera device 105.

According to various aspects of the subject technology, proper installation of the camera device 105 may be confirmed and tested by insurance personnel, either remotely or in person. For example, a representative of the insurance company may retrieve the recorded video associated with the customer and determine whether the recorded video is within the established parameters (e.g., with an adequate viewing radius and within a particular range of viewing angles) and whether the recorded video has been automatically transmitted to the system's servers. The representative may also inspect the camera device 105 in person to confirm that the camera device 105 is installed correctly, records video within the established parameters, and automatically transmits the recorded video to the system's servers. According to other aspects of the subject technology, however, proper installation of the camera device 105 may be confirmed automatically by the system 130.

Once the camera device 105 is set up and registered (e.g., linked to the customer's insurance account), the camera device 105 may be configured to automatically transmit a recorded data feed, including video data, to one or more servers of the system 130. Once the feed is received and tested to see if the feed corresponds to the specified criteria, the system 130 may identify an insurance product to provide to the user, and then provide the user with the identified insurance product. For example, the system 130 may apply a discount to the customer's insurance account.

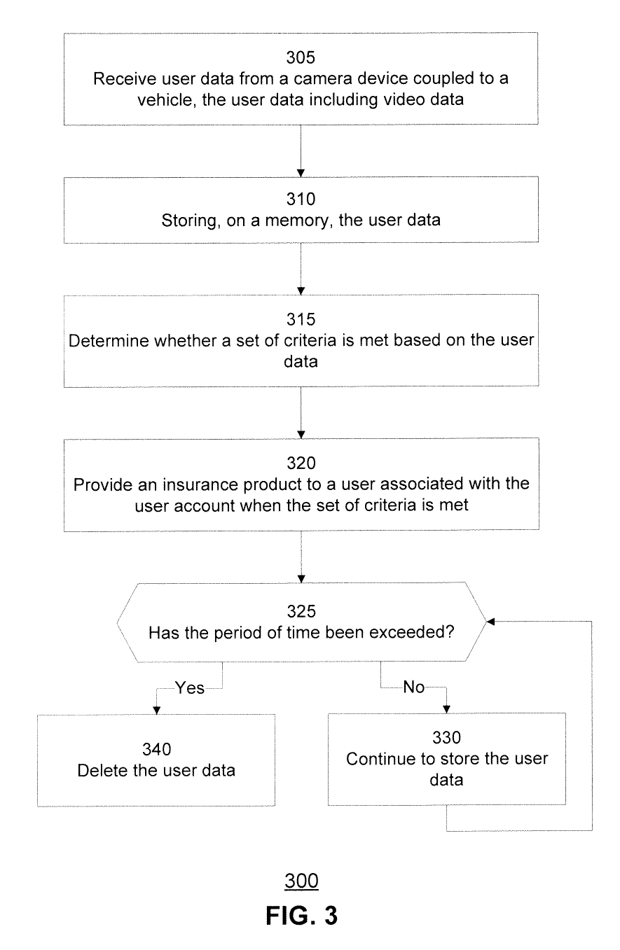

FIG. 3 is a flow chart illustrating an example process 300 for providing an insurance product to a user in accordance with various aspects of the subject technology. Although the blocks in FIG. 3 are shown in a particular order, other orderings are also possible. For example, some blocks may be performed in different orders or in parallel with other blocks.

At block 305, the system 130 may receive user data from a camera device 105 coupled to a vehicle over a network such as network 150 in FIG. 1. The user data may include information from the camera device 105. For example, the user data may include recorded data such as video data (e.g., a video feed), image data, or audio data. The user data may also include a camera device 105 identifier (e.g., a camera ID, a user ID, a user account identifier, etc.), camera device 105 configuration details, or user information (e.g., user account information). The user data may also include information from other components of the camera device 105 such as a geographical location (e.g., GPS location coordinates) from a GPS component 225, proximity information from a proximity sensor, or any other information generated by the camera device 105. The system 130 may store the user data received from the camera device 105 on a memory such as database 135 at block 310.

The system 130, at block 315, may determine whether a set of criteria needed to provide an insurance product is met. The system 130 may determine whether the set of criteria is met based on the user data. For example, one illustrative set of criteria may include that the camera device 105 is properly installed, that the camera device 105 is associated with a user with an existing automobile insurance policy, and that the camera device 105 has transmitted at least a threshold amount of video data to the system 130.

According to the illustrative example above, the system 130 may determine whether the camera device 105 is properly installed based on the configuration details of the camera device 105 and the video data received from the camera device 105. The system 130 may also determine whether the camera device 105 is associated with a user and whether the user has an existing automobile insurance policy based on a camera identifier in the user data. The system 130 may also access the user data stored on the database 135 to determine whether the camera device 105 has transmitted at least the threshold amount of video data to the system 130.

If the set of criteria is met, at block 320, the system 130 may provide the insurance product associated with the set of criteria to the user. For example, if the insurance product is a discount on an automobile insurance policy, the system 130 may automatically apply the discount to the automobile insurance policy of the user. In other implementations, the system 130 may provide the user with an offer (e.g., through the mail, email, instant messaging, text messaging, or through other means) to obtain a discount for the automobile insurance policy.

According to some aspects of the subject technology, the insurance product may be provided only when the set of criteria is met. For example, if one of the criteria is that video data be presently received from the camera device 105, the system 130 may provide the insurance produce (e.g., apply the discount to the automobile insurance policy) for only the time that video data was received from the camera device 105. Accordingly, a discount may be applied for a portion of a billing cycle rather for the entire billing cycle. Furthermore, the amount of discount may be varied based on the amount of time that the set of criteria is met.

According to some aspects of the subject technology, the user data received from the camera device 105 is only stored by the system 130 for a limited period of time (e.g., 1 week) and deleted when the “life” of the user data has expired at the end of that period of time.

The user data may be associated with temporal data that indicates the time that the user data was created, transmitted, or received by the system 130. For example, the video data may be time-coded with temporal data (e.g., time-stamped) corresponding to the time the video data was recorded by the camera device 105. Using the temporal data, the system 130 may determine whether the period of time that the user data is to be stored has been exceeded at block 325.

If the period of time has not been exceeded, at block 330, the user data may continue to be stored by the system 130. On the other hand, if the period of time has been exceeded, the system 130 may delete the user data at block 340. By deleting the video content after a period of time, the system 130 may help alleviate some customer concerns associated with keeping the video content indefinitely or for a longer period of time. The system 130 may also reduce the computing resources needed to store additional video content. According to various aspects of the subject technology, a user receiving a discount may be required to report a traffic accident or any other incident within a reporting period which is shorter than the amount of time that the user data is stored by the system (e.g., 3 days) so that the user data corresponding to the accident or traffic incident will still be accessible by the system 130 when the traffic incident is reported.

According to some aspects of the subject technology, the user data stored by the system 130, which may include video data from a video feed, may provide the insurance platform with information about surrounding circumstances and events should an incident occur. For example, if a traffic incident such as an accident occurs, the video data stored by the system 130 may provide the insurance platform or another entity with a record of events from the viewpoint of the vehicle in the accident. The video data may also be used in deciphering insurance fraud. Although the examples above refer to the use of video data, other information included in the user data may similarly be used. According to some aspects of the subject technology, the system 130 may provide real time user data to an insurance company looking to make sure that a claim is valid and not fraudulent. The system may also save the insurance company money by allowing the company to cut down on investigation costs.

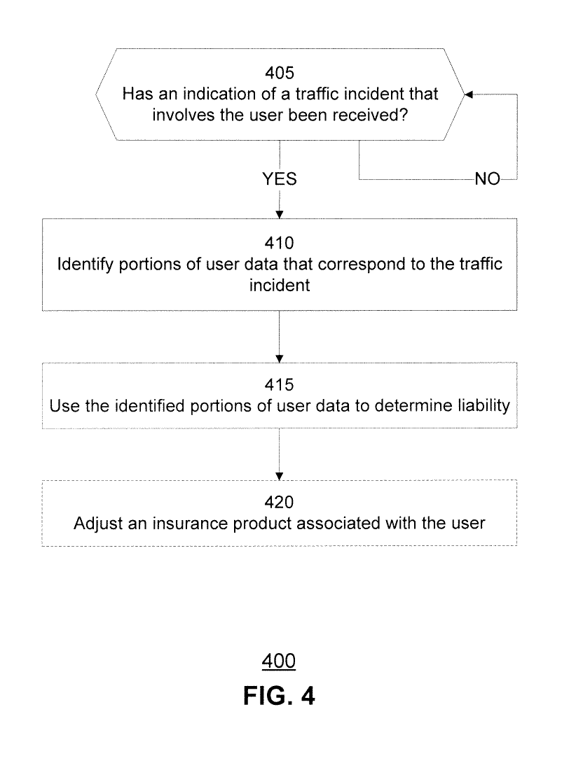

FIG. 4 is a flow chart illustrating an example process 400 for using the stored user data, in accordance with various aspects of the subject technology. Although the blocks in FIG. 4 are shown in a particular order, other orderings are also possible. For example, some blocks may be performed in different orders or in parallel with other blocks.

Process 400 illustrates the use of stored user data for dealing with traffic incidents. However, the user data may be used for other types of events as well. Accordingly, the system 130 may first determine whether a traffic incident has occurred by determining whether an indication of a traffic incident that involves the user has been received at block 405. The indication may include the reporting of the traffic incident by the user or a third party (e.g., another participant in the traffic incident, another insurance company, or a governmental agency), the submission of an insurance claim that includes the user, or an administrative agent entering the details of the traffic incident into the system 130. The indication may include information such as the user's name, an insurance policy or account identifier, a location, a date and time, or additional details about the incident.

The system 130 may identify stored user data associated with the user and identify portions of the user data that correspond to the traffic incident at block 410. The user data may be identified based on the name of the user, the insurance policy or account identifier, or a combination of information. Furthermore, the user data that corresponds to the traffic incident may be identified based on the date and time and/or the location of the traffic incident. For example, the user data may be time-coded with temporal data that corresponds to the date and time the user data was generated by the camera device. Furthermore, user data may be associated with a geographic location (e.g., GPS coordinates) corresponding to the location where the user data was generated. Accordingly segments of video data that correspond to the time and/or location of the traffic incident may be identified. Other user data that correspond to the time and/or location of the traffic incident may similarly be identified.

The identified portions of user data may be used to construct an accurate record of the events leading up to, during, and after the traffic incident and at block 415, the identified portions of user data may be used to determine liability for the traffic incident. For example, an administrator may view segments of the video data corresponding to the traffic incident to determine what happened. Accordingly, liability for the traffic incident may be determined with more accuracy and more confidence than if the user data were not available. Furthermore, if more than one participant in the traffic incident also had user data stored from their respective camera devices, the additional sets of user data may also be used in constructing an accurate record of the traffic incident and determining liability.

According to some aspects of the subject technology, the system 130 may also optionally adjust an insurance product associated with the user at block 420. For example, a user's automobile insurance may have a rate or other fees increased or decreased. In certain aspects, a notification would be provided to the user informing the user of the change in fees. The insurance product may be adjusted based on the user data associated with the traffic incident and/or the determination of liability.

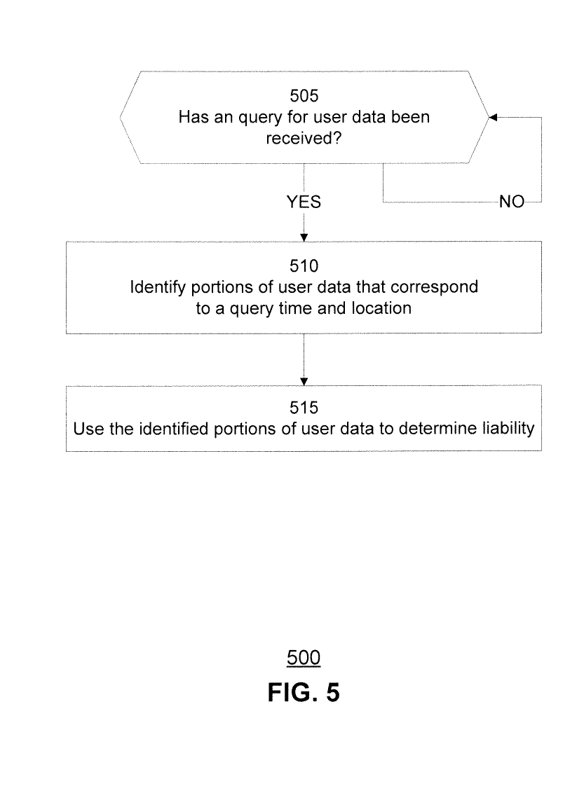

Although the process 400 relates to traffic incidents that involve the user, according to other aspects of the subject technology, the user associated with the user data need not be involved in the traffic incident. For example, FIG. 5 is a flow chart illustrating another example process 500 for using the stored user data, in accordance with various aspects of the subject technology. Although the blocks in FIG. 5 are shown in a particular order, other orderings are also possible. For example, some blocks may be performed in different orders or in parallel with other blocks.

At block 505, the system 130 may determine whether a query for user data has been received. The query may be received from an administrator looking for information about a particular event, such as a traffic incident. The query may include a date, a time, and/or a location. The location may include an address, location coordinates, an intersection, or any other location description.

At block 510, the system 130 may identify portions of user data that correspond to the query. For example, the system 130 may search for all user data that correspond to the query date/time and location. The user data may come from one or more users and camera devices including from users that are not directly involved with the particular event that is the subject of the query. Accordingly, the system 130 may be able to locate user data from other users that may potentially be bystanders or witnesses to a traffic incident even if the people involved directly in the traffic incident do not have camera devices to capture their own user data. The identified portions of user data may be used, at block 515, to construct an accurate record of the event and, if the event is a traffic incident, determine liability. For example, an administrator may view segments of the video data corresponding to the traffic incident to determine what happened.

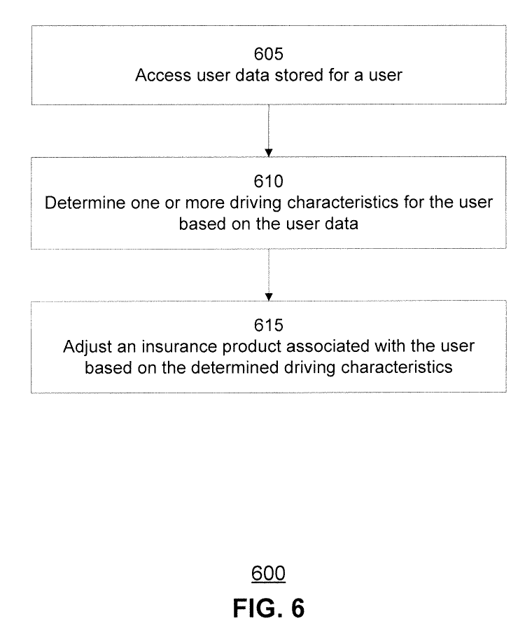

According to other aspects of the subject technology, the user data stored by the system 130 may be used to determine user driving characteristics and adjust insurance products. For example, FIG. 6 is a flow chart illustrating another example process 600 for using the stored user data in accordance with various aspects of the subject technology. Although the blocks in FIG. 6 are shown in a particular order, other orderings are also possible. For example, some blocks may be performed in different orders or in parallel with other blocks.

At block 605, the system 130 may access user data for a user and determine one or more driving characteristics for the user based on the user data at block 610. For example, the system 130 may analyze the video data for the user to determine, for example, how close the user drives behind other vehicles, how close the user gets to pedestrians, bicyclers, or other object, how closely the user parks the vehicle to other objects, how hard a user brakes, whether the user operates his vehicle during adverse weather conditions, etc. The user data may also be used to determine the typical times of day that the user drives, how long the user drives, and where the user drives. User data from other sensors such as a proximity sensor, a gyroscope, or a GPS device, may also be used to determine driving characteristics of the user.

The system 130 may use the determined driving characteristics at block 615 to adjust an insurance product associated with the user. For example, a user's automobile insurance may have a rate or other fees increased or decreased. Discounts, bonus offers, or other products may be also provided to the user.

According to various aspects of the subject technology, before using any of the user data collected and stored, the system 130 may first obtain the consent of the user to use his user data. Furthermore, additional measures may be taken to anonymize the data when it is stored and protect the data from other entities and other unauthorized users.

According to various aspects of the subject technology, when a camera device such as a dashboard camera is setup and a video feed from the camera device is confirmed to be received properly, the system may apply a discount to the customer's insurance account for that vehicle for as long as the automated feed of video content was working and being received from the camera device. According to some aspects, a discount may be applied immediately after the automated video feed is confirmed to be working In other variations, however, the system may wait a probationary period of time (e.g., 3 days) to determine that no problems with the feed arise. After the probationary period of time, if no problems arise and the feed is consistently received, the system may apply the discount to the customer's insurance account.

Aspects of the subject technology also relate to a mechanism implemented by the system to ensure that the feed received from a user's camera device remains acceptable. For example, the system or an insurance company representative may determine that the feed from a camera device no longer meets the requirements of the system. The feed may no longer be acceptable if, for example, the camera device is not properly set up, is no longer aligned because of some shifting during the operation of the automobile, or is tampered with.

According to some aspects of the subject technology, the system may transmit a message to the application that notifies the user that the camera device is not properly set up. The message may also include instructions on how to fix the camera device. In some cases, the message may also warn the customer that if the camera device is not properly set up within a certain period of time (e.g., 5 days) the insurance discount may no longer be applied to the customer's insurance account. According to other aspects of the subject technology, the message may be transmitted using other means as well (e.g., an email, a text message, a call to the customer, a letter in the mail). According to some aspects, the system may automatically determine that the feed from a camera device no longer meets the requirements, identify a solution, and transmit instructions to the camera device to reorient itself (e.g., zoom in or out, pan in one direction, etc.) in order to fix the feed from the camera device.

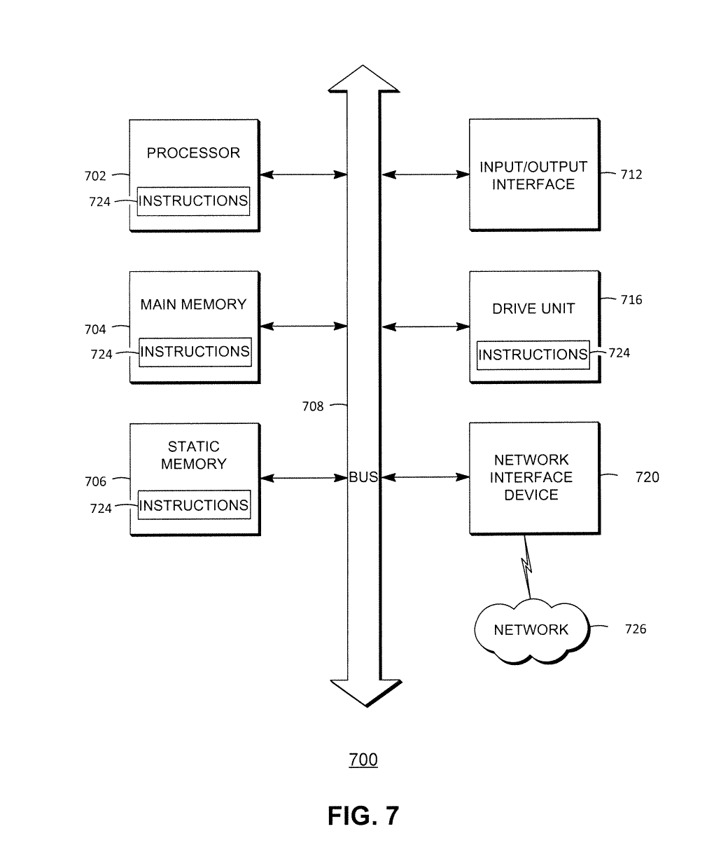

FIG. 7 is a block diagram illustrating an example computer system 700 with which any of the computing machines, devices, or systems discussed herein may be implemented, in accordance with some aspects of the subject technology. In certain aspects, the computer system 700 may be implemented using hardware or a combination of software and hardware, either in a dedicated server, or integrated into another entity, or distributed across multiple entities.

The example computer system 700 includes a processor 702, a main memory 704, a static memory 706, a disk drive unit 716, and a network interface device 720 which communicate with each other via a bus 708. The computer system 700 may further include an input/output interface 712 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 702 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 724 embodying any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media. The instructions 724 may further be transmitted or received over a network 726 via the network interface device 720.

The machine-readable medium may be a single medium or multiple media (e.g., a centralized or distributed database; and/or associated caches and servers) that store the one or more sets of instructions. The machine-readable medium may include the drive unit 716, the static memory 706, the main memory 704, the processor 702, an external memory connected to the input/output interface 712, or some other^{s} memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

The various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology: A disclosure relating to a configuration may apply to all configurations, or one or more configurations. A configuration may provide one or more examples. A phrase such a configuration may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method comprising:
receiving user data from at least one camera device coupled to a vehicle, wherein the user data comprises video data;
determining, based on the user data, whether a set of criteria is met; and
providing, using a processor, an insurance product to a user associated with the camera device when the set of criteria is met.

2. The method of claim 1, wherein the at least one camera device coupled to the vehicle comprises a dashboard camera device mounted in a cabin of the vehicle of the user.

3. The method of claim 1, wherein the video data is of a front-facing vehicle view and wherein the video data is time-coded with temporal data associated with the video data.

4. The method of claim 3, wherein the user data further comprises a geographical location associated with the video data.

5. The method of claim 4, wherein the geographical location is generated by a GPS device associated with the at least one camera device.

6. The method of claim 4, further comprising storing the video data in a memory associated with the at least one camera device.

7. The method of claim 6, further comprising:
receiving a query time and location; and
identifying segments of the video data that correspond to the query time and location based on the temporal data and the geographical location associated with the video data.

8. The method of claim 1, wherein the insurance product comprises a discount to be applied to an insurance policy, and wherein providing the user with the insurance product comprises applying the discount to an insurance policy associated with the user.

9. The method of claim 1, wherein the insurance product comprises an offer of a discount to be applied to an insurance policy, and wherein providing the user with the insurance product comprises transmitting the offer to the user.

10. The method of claim 1, wherein the set of criteria comprises at least one of whether the received video data corresponds to an amount of time that exceeds a threshold amount of time, whether the received video data exceeds a threshold quality level, or whether the at least one camera device is installed correctly.

11. The method of claim 1, wherein the at least one camera device is associated with a user account provided by an insurance platform, the method further comprising registering the at least one camera device with the user account.

12. The method of claim 1, further comprising transmitting instructions to the at least one camera device, wherein the at least one camera device is configured to alter at least one of a zoom level, a subject of focus, or an angle of view based on the instructions.

13. A system comprising:
one or more processors; and
a machine-readable medium comprising instructions stored therein, which when executed by the one or more processors, cause the one or more processors to perform operations comprising:
receiving user data from at least one camera device coupled to a vehicle, wherein the user data comprises video data;
storing, on a memory, the video data;
determining, based on the user data, whether a set of criteria is met; and
providing, using a processor, an insurance product to a user associated with camera device when the set of criteria is met.

14. The system of claim 13, wherein the video data is stored on the memory for a period of time, and wherein the operations further comprise automatically deleting the video data from the memory when the period of time expires.

15. The system of claim 13, wherein the operations further comprise:
receiving an indication of a traffic incident at a particular time; and
identifying segments of the video data that correspond to the traffic incident.

16. The system of claim 15, wherein the traffic incident is associated with the user, and wherein the operations further comprise adjusting an insurance product associated with the user based on the identified segments of the video data.

17. The system of claim 13, wherein the insurance product comprises a discount to be applied to an insurance policy, and wherein providing the user with the insurance product comprises applying the discount to an insurance policy associated with the user.

18. The system of claim 13, wherein the set of criteria comprises at least one of whether the received video data corresponds to an amount of time that exceeds a threshold amount of time, whether the received video data exceeds a threshold quality level, or whether the at least one camera device is installed correctly.

19. A non-transitory machine-readable medium comprising instructions stored therein, which when executed by a machine, cause the machine to perform operations comprising:
receiving a video feed from at least one camera device associated with a user of an insurance platform;
storing, on a memory, the video feed for a period of time; and
providing, using a processor, a discount to the user based on the storing of the video feed.

20. The non-transitory machine-readable medium of claim 19, wherein the operations further comprise:
determining one or more driving characteristics for the user based on the video feed; and
adjusting an insurance product associated with the user based on the determined one or more driving characteristics.
